(19) United States
(12) Patent Application Publication
(10) Pub. No.: US 2012/0001840 A1
(43) Pub. Date: Jan. 5, 2012

(54) LIQUID CRYSTAL DISPLAY DEVICE

(76) Inventors: Hiroyuki Ohgami, Osaka (JP); Yoshito Hashimoto, Osaka (JP); Ken Kuboki, Osaka (JP); Seiji Tanuma, Osaka (JP)

(21) Appl. No.: 13/203,108

(22) PCT Filed: Dec. 17, 2009
(86) PCT No.: PCT/JP2009/006960

§ 371 Date: Sep. 13, 2011

(30) Foreign Application Priority Data
Feb. 24, 2009 (JP) 2009-041288

(51) Int. Cl. G09G 3/36

(52) U.S. Cl. 345/92

(57) ABSTRACT

A liquid crystal display device providing a high image quality with good viewing angle characteristics and being produced at a high efficiency is provided. A liquid crystal display device according to the present invention includes a TFT substrate including a plurality of pixel electrodes in correspondence with a plurality of pixels, respectively; a counter substrate including a counter electrode facing the plurality of pixel electrodes; and a liquid crystal layer located between the TFT substrate and the counter substrate. The plurality of pixel electrodes each include a first trunk portion, a plurality of first branch portions extending from the first trunk portion in a first direction, and a plurality of second branch portions extending from the first trunk portion in a direction opposite to the first direction. The counter electrode includes, in each of the plurality of pixels, a plurality of branch portions extending in a second direction, which is perpendicular to the first direction in a substrate plane.

### TECHNICAL FIELD

The present invention relates to a liquid crystal display device, and specifically to a liquid crystal display device having a plurality of alignment domains in a pixel.

### BACKGROUND ART

Currently, as liquid crystal display devices having a wide viewing angle characteristic, the following liquid crystal display devices have been developed, for example: liquid crystal display devices using an IPS (In-Plane-Switching) mode or an FFS (Fringe Field Switching) mode, which are transverse electric field modes, and liquid crystal display devices using a VA (Vertical Alignment) mode.

VA-mode liquid crystal display devices include, for example, liquid crystal display devices of an MVA (Multidomain Vertical Alignment) mode in which a plurality of domains having different alignment directions of liquid crystal molecules are formed in one pixel, and liquid crystal display devices of a CPA (Continuous Pinwheel Alignment) mode in which the alignment direction of liquid crystal molecules is continuously varied around a rivet or the like formed on an electrode at the center of the pixel.

An example of MVA-mode liquid crystal display device is described in Patent Document 1. In the liquid crystal display device described in Patent Document 1, alignment regulation means extending in two directions perpendicular to each other is provided. Owing to this, four liquid crystal domains are formed in one pixel in which the azimuthal angle of directors which are representative of the respective liquid crystal domains is 45° with respect to polarization axes (transmission axes) of a pair of polarizing plates placed in crossed Nicols. Where the azimuthal angle of 0° corresponds to the direction of the polarization axis of one of the polarizing plates and the counterclockwise direction is the positive direction, the azimuthal angles of the directors of the four liquid crystal domains are 45°, 135°, 225°, and 315°. Such a structure in which four domains are formed in one pixel is referred to as the “4-domain alignment structure” or simply as the “4D structure”.

Another example of MVA-mode liquid crystal display device is described in Patent Document 2. The liquid crystal display device described in Patent Document 2 includes pixel electrodes having many tiny slits (cutouts) extending in an azimuthal angle direction of 45°-225° and an azimuthal angle direction of 135°-315° (such pixel electrodes are referred to as the “comb-shaped pixel electrodes” or “fishbone-type pixel electrodes”). The 4-domain alignment structure is realized by aligning liquid crystal molecules to be parallel to these slits.

Patent Document 3 describes vertical alignment type liquid crystal molecules in which a pixel electrode and a counter electrode both having a peculiar shape each have a plurality of parallel slits. The plurality of slits of the pixel electrode and the plurality of slits of the counter electrode are located alternately to each other. In Example 1 of Patent Document 3, all the slits extend in a direction of 45° with respect to the transmission axes of the polarizing plates. In Example 2, all the slits extend parallel or perpendicular to the transmission axes of the polarizing plates.

### CITATION LIST

### Patent Literature

Patent Document 1: Japanese Laid-Open Patent Publication No. 11-242225
Patent Document 2: Japanese Laid-Open Patent Publication No. 2003-149647
Patent Document 3: Japanese Laid-Open Patent Publication No. 2007-187826

### SUMMARY OF INVENTION

### Technical Problem

FIG. 8 is a plan view schematically showing a structure of one pixel 110 in a liquid crystal display device 100 including pixel electrodes 130 of the fishbone type described in Patent Document 2. The liquid crystal display device 100 is a vertical alignment type liquid crystal display device including a liquid crystal material having a negative dielectric anisotropy. In a TFT substrate of the liquid crystal display device 100, a plurality of scanning lines 122 extending in a left-right direction of the figure (X direction) and a plurality of signal lines 123 extending in an up-down direction of the FIG. 1 direction) are provided. In the TFT substrate, TFTs 135 are provided in correspondence with the pixels 110, respectively.

The pixel electrode 130 includes a trunk portion (trunk electrode) 130a extending in the X direction and a trunk portion 130b extending in the Y direction. Hereinafter, in order to define directions (directions of azimuthal angles) in a plane of the TFT substrate (in a plane of the pixel electrode), a direction toward the positive side in the X direction (rightward in the figure) from the center of an intersection of the trunk portion 130a and the trunk portion 130b is set as the “0° direction”, and azimuthal angles are defined counterclockwise. Namely, the trunk portion 130a extends in the 0°-180° direction, and the trunk portion 130b extends in the 90°-270° direction. The pixel electrode 130 further includes a plurality of branch portions (branch electrodes) 130c extending in a direction of 45° from the trunk portion 130a or 130b, a plurality of branch portions 130d extending in a direction of 135° from the trunk portion 130a or 130b, a plurality of branch portions 130e extending in a direction of 225° from the trunk portion 130a or 130b, and a plurality of branch portions 130f extending in a direction of 315° from the trunk portion 130a or 130b.

The liquid crystal display device 100 includes two polarizing plates located in crossed Nicols while having a liquid crystal layer interposed therebetween. Among transmission axes 140a and 140b of the two polarizing plates, one extends in the 0°-180° direction (X direction), and the other extends in the 90°-270° direction (Y direction). In the absence of a voltage applied to the liquid crystal layer, black display is provided. When a voltage is applied to the liquid crystal layer, the polarization plane of incident light is rotated by the aligned liquid crystal molecules to provide white display.

In order to improve the utilization efficiency of light, it is preferable to align the liquid crystal molecules in directions of azimuthal angle of 45° (directions which are different by 45°) with respect to the transmission axes 140a and 140b at the time of voltage application. Therefore, the branch portions 130c through 130f extend in the directions of 45° with respect to the transmission axes 140a and 140b. When a voltage is applied, the liquid crystal molecules are aligned in the directions in which the branch portions 130c through 130f extend.

On a surface of the pixel electrode 130 on the liquid crystal layer side and on a surface of the counter electrode on the liquid crystal layer side, vertical alignment films are provided for aligning the liquid crystal molecules approximately vertically to the surfaces of the substrates in the absence of a voltage. On surfaces of the vertical alignment films on the liquid crystal layer side, alignment sustaining layers are formed. The alignment sustaining layers are formed of a polymer which is formed as follows. After the liquid crystal cell is formed, a photopolymerizable monomer mixed in advance in the liquid crystal material is photopolymerized in the state where a voltage is applied to the liquid crystal layer. For polymerizing the monomer, a voltage is applied to the liquid crystal layer by the pixel electrode 130 and the counter electrode, and the liquid crystal molecules are irradiated with light in the state where the liquid crystal molecules are aligned an oblique electric field generated in accordance with the shape of the pixel electrode 130.

Owing to the alignment sustaining layers formed in this manner, the alignment (pretilt azimuth) can be sustained (stored) in the liquid crystal molecules even in the absence of a voltage. Such a technology of forming the alignment layers is referred to as the “polymer sustained alignment” technology (PSA). The details thereof are described in Patent Document 2. In the absence of a voltage applied to the liquid crystal layer at the time of display, the liquid crystal molecules are pretilted in a direction slightly inclined from the direction vertical to the substrate surface by the action of the alignment sustaining layers. Thus, the response speed to realize the alignment of the liquid crystal molecules when a voltage is applied is improved.

However, the liquid crystal display device 100 has a problem that the production thereof requires a step of forming the alignment sustaining layers described above, which lowers the production efficiency. There is another problem that since the liquid crystal molecules are not aligned completely vertically to the substrate surface in the absence of a voltage, light leaks in the black display and so a good contrast is not obtained.

FIG. 9 is a plan view showing a shape of a pair of electrodes (pixel electrode and counter electrode) 150 in a liquid crystal display device described in Patent Document 3. FIG. 10(a) is a plan view schematically showing a part of the pair of electrodes 150, and FIG. 10(b) is a cross-sectional view schematically showing the shape of a cross-section taken along B-B′ in FIG. 10(a).

As shown in FIG. 9, the liquid crystal display device uses the electrodes 150 of a peculiar shape. Each electrode 150 has a plurality of slits 155a and 155b extending in a direction of 45° with respect to transmission axes 160a and 160b of polarizing plates. Liquid crystal molecules 151 are aligned nearly vertically to the substrate surface in the absence of a voltage. When a voltage is applied, as shown in FIG. 10(a) and FIG. 10(b), the liquid crystal molecules 151 are aligned approximately perpendicularly to a longitudinal direction of the slits 155a and 155b by an alignment anchoring force of the slits 155a and 155b. In this manner, two types of domains having different alignment directions of the liquid crystal molecules 151 are formed in the pixel.

However, the liquid crystal display device described in Patent Document 3 has the following problem. The slits 155a and 155b each have a large width (width in the direction perpendicular to the direction in which the slits extend), and have a short length (length in the direction in which the slits extend). Therefore, as represented with reference sign 151′ in FIG. 10(a), many liquid crystal molecules 151′, the alignment azimuth of which is not stable in the presence of a voltage (or liquid crystal molecules 151′ which are not aligned in desired directions) are present between two adjacent slits. When such liquid crystal molecules 151′ are present, the transmission efficiency of light during white display is reduced to lower the luminance.

Also in the absence of a voltage, there is the following problem. A relatively large number of liquid crystal molecules 151 are caused to align obliquely by the steps or inclined surfaces of the electrode material at ends of the slits 155a and 155b (edges of the electrode 150). Accordingly, light leaks and so a good contrast is not obtained.

The present invention, made for solving at least one of the problems, has an object of providing a liquid crystal display device which provides a high contrast and is produced at a high efficiency.

### Solution to Problem

Provided according to a first aspect of the present invention is a liquid crystal display device of a vertical alignment type including a plurality of pixels, the liquid crystal display device including: a TFT substrate including a plurality of pixel electrodes and a plurality of TFTs both in correspondence with the plurality of pixels, respectively; a counter substrate including a counter electrode facing the plurality of pixel electrodes; and a liquid crystal layer located between the TFT substrate and the counter substrate. The plurality of pixel electrodes each include a first trunk portion, a plurality of first branch portions extending from the first trunk portion in a first direction, and a plurality of second branch portions extending from the first trunk portion in a direction opposite to the first direction; and the counter electrode includes, in each of the plurality of pixels, a plurality of branch portions extending in a second direction, which is perpendicular to the first direction in a substrate plane.

Provided according to a second aspect of the present invention based on the first aspect is a liquid crystal display device, wherein the counter electrode includes, in each of the plurality of pixels, a second trunk portion extending in a direction different from the second direction; and the branch portions of the counter electrode include a plurality of third branch portions extending from the second trunk portion in the second direction and a plurality of fourth branch portions extending in a direction opposite to the third direction.

Provided according to a third aspect of the present invention based on the first or second aspect is a liquid crystal display device, wherein the second trunk portion extends in a direction perpendicular to the second direction in the substrate plane.

Provided according to a fourth aspect of the present invention based on any one of the first through third aspects is a liquid crystal display device, wherein the first trunk portion extends in a direction perpendicular to the first direction in the substrate plane.

Provided according to a fifth aspect of the present invention based on any one of the first through fourth aspects is a liquid crystal display device, wherein the plurality of first branch portions and the plurality of second branch portions each have a width of 1.5 μm or greater and 8.0 μm or less.

Provided according to a sixth aspect of the present invention based on any one of the first through fifth aspects is a liquid crystal display device, wherein the plurality of branch portions of the counter electrode each have a width of 1.5 μm or greater and 8.0 μm or less.

Provided according to a seventh aspect of the present invention based on any one of the first through sixth aspects is a liquid crystal display device, wherein slits interposed between two adjacent first branch portions, among the plurality of first branch portions, and slits interposed between two adjacent second branch portions, among the plurality of second branch portions, each have a width of 1.5 μm or greater and 5.0 μm or less.

Provided according to an eighth aspect of the present invention based on any one of the first through seventh aspects is a liquid crystal display device, wherein slits interposed between two adjacent branch portions, among the plurality of branch portions of the counter electrode, each have a width of 1.5 μm or greater and 5.0 μm or less.

Provided according to a ninth aspect of the present invention based on any one of the first through eighth aspects is a liquid crystal display device, further including a first polarizing plate attached to the TFT substrate and having a transmission axis extending parallel or perpendicular to the first direction; and a second polarizing plate attached to the counter substrate and having a transmission axis perpendicular to the transmission axis of the first polarizing plate.

Provided according to a tenth aspect of the present invention based on any one of the first through ninth aspects is a liquid crystal display device, wherein an alignment film is provided, on a surface of at least one of the TFT substrate and the counter substrate on the liquid crystal layer side, so as to be in contact with the liquid crystal layer, the alignment film being for aligning liquid crystal molecules vertically to the surfaces of the substrates in the absence of a voltage.

Provided according to an eleventh aspect of the present invention based on any one of the first through tenth aspects is a liquid crystal display device, wherein the liquid crystal molecules located in a middle portion of the liquid crystal layer in a direction vertical to the surfaces of the substrates are aligned in a direction of 45° with respect to the first direction in the substrate plane when a voltage is applied.

Provided according to a twelfth aspect of the present invention based on any one of the first through eleventh aspects is a liquid crystal display device, wherein the liquid crystal molecules located in the vicinity of the TFT substrate are aligned parallel to the first branch portions or the second branch portions in the substrate plane when a voltage is applied.

Provided according to a thirteenth aspect of the present invention based on any one of the first through twelfth aspects is a liquid crystal display device, wherein the liquid crystal molecules located in the vicinity of the counter substrate are aligned parallel to the branch portions of the counter electrode in the substrate plane when a voltage is applied.

### Advantageous Effects of Invention

According to the present invention, a liquid crystal display device which provides a high contrast and high viewing angle characteristics and is produced at a high efficiency can be provided.

### BRIEF DESCRIPTION OF DRAWINGS

FIG. 1 is a plan view schematically showing a structure of one pixel 15 in a liquid crystal display device 10 in Embodiment 1 according to the present invention.

FIG. 2 is a cross-sectional view of the liquid crystal display device 10 taken along line A-A′ in FIG. 1.

FIG. 3(a) is a plan view schematically showing a shape of a pixel electrode 30 in the liquid crystal display device 10, and FIG. 3(b) is a plan view schematically showing a shape of a counter electrode 45 in the liquid crystal display device 10.

FIG. 4(a) shows the alignment of liquid crystal molecules 51 in the liquid crystal display device 10, and FIG. 4(b) shows the alignment of liquid crystal molecules 151 in a conventional liquid crystal display device including a pixel electrode 130 of a fishbone type.

FIGS. 5(a) and 5(b) respectively show a state of the liquid crystal molecules 51 in the vicinity of the pixel electrode 30 and a state of the liquid crystal molecules 51 in the vicinity of the counter electrode 45, in the presence of a voltage, and FIGS. 5(c) and 5(d) each show an alignment state of the liquid crystal molecules 51 in four domains formed when a voltage is applied.

FIGS. 6(a) and 6(b) respectively show displays of the pixel 15 in the absence of a voltage and in the presence of a voltage.

FIG. 7 shows an effect provided by the liquid crystal display device 10.

FIG. 8 is a plan view schematically showing a structure of one pixel in a conventional liquid crystal display device 100 including the pixel electrode 130 of the fishbone type.

FIG. 9 is a plan view showing a structure of a pair of electrodes 150 including a plurality of slits 155a and 155b in a conventional liquid crystal display device.

FIG. 10(a) is a plan view schematically showing a part of the pair of electrodes 150, and FIG. 10(b) schematically shows a cross-section thereof taken along B-B′ in FIG. 10(a).

### DESCRIPTION OF EMBODIMENTS

Hereinafter, a structure of a liquid crystal display device in an embodiment according to the present invention will be described, but the present invention is not limited to the embodiment described below.

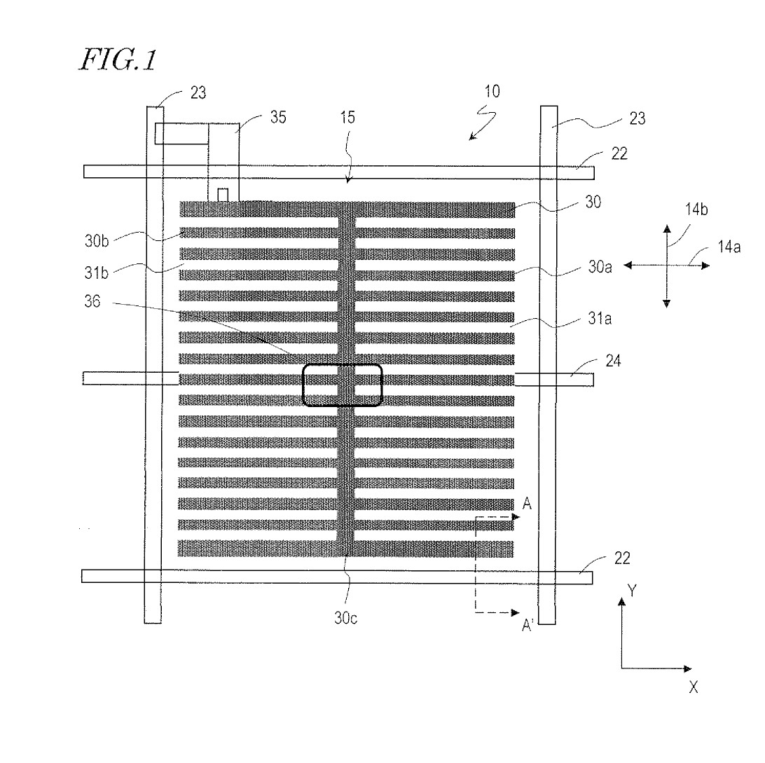

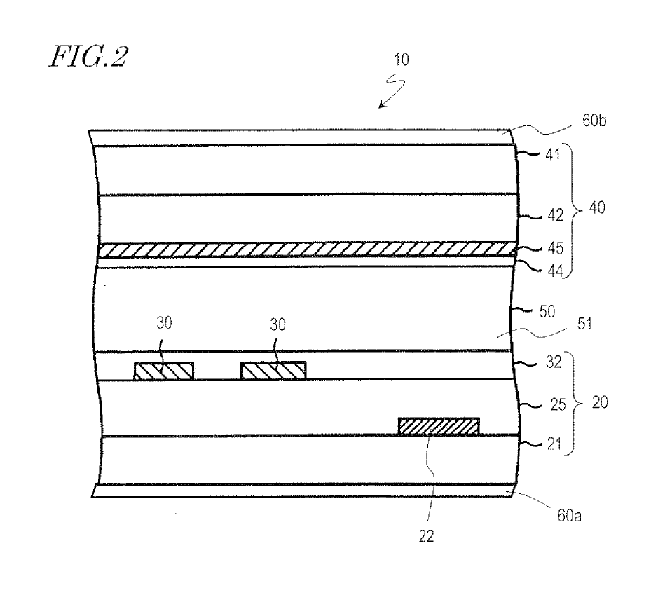

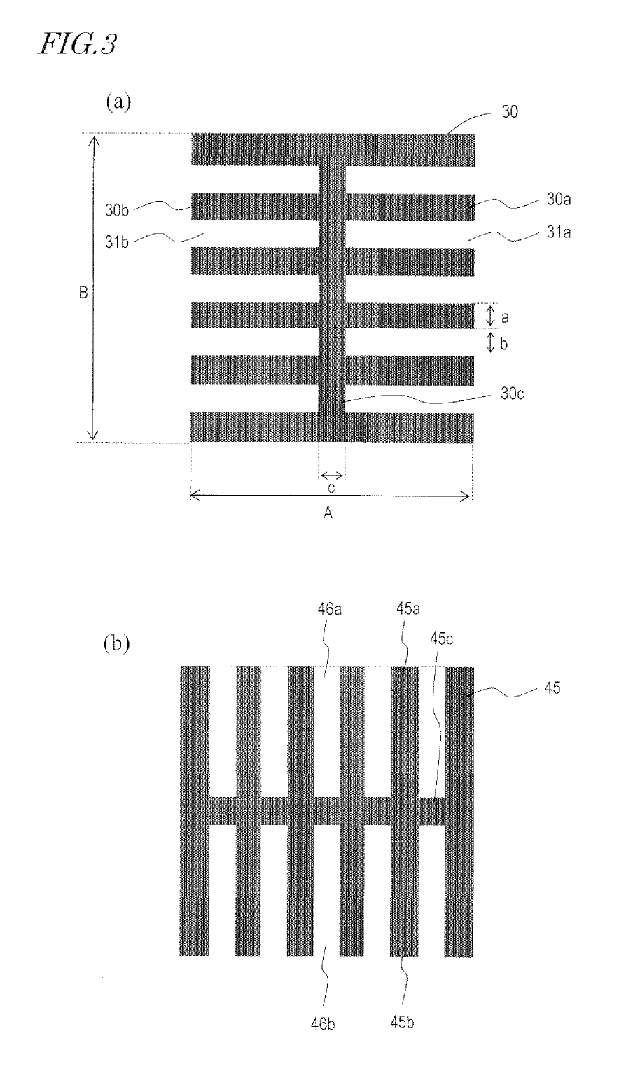

FIG. 1 is a plan view schematically showing a structure of one pixel 15 in a liquid crystal display device 10 in Embodiment 1 according to the present invention. FIG. 2 is a schematic cross-sectional view of the liquid crystal display device 10 taken along line A-A′ in FIG. 1. FIG. 3(a) is a plan view schematically showing a shape of a pixel electrode 30 in the liquid crystal display device 10, and FIG. 3(b) is a plan view schematically showing a shape of a counter electrode (common electrode) 45 corresponding to one pixel 15.

The liquid crystal display device 10 is of a vertical alignment type and includes a plurality of pixels 15, each having a structure shown in FIG. 1, which are arranged in a matrix in an X direction (left-right direction in the figure) and a Y direction (top-bottom direction in the figure). The liquid crystal display device 10 provides display in a normally black mode by the pixels 15. A minimum display unit is formed of three primary colors of R (red), G (green) and B (blue), and each pixel 15 corresponds to a display area of one color among R, G and B. Three pixels 15 continuously placed in the X direction or the Y direction correspond to three pixels of R, G and B. The minimum display unit is formed of these three pixels 15.

The minimum display unit may be formed of four or more primary colors (multiple primary color display). In such a case, each pixel 15 corresponds to a display area of one color among a plurality of primary colors which form the minimum display unit. Alternatively, one color of the minimum unit can be displayed by a plurality of pixel electrodes which are electrically separated from each other. In such a case, each pixel 15 corresponds to an area of one such separated pixel electrode (and one TFT).

As shown in FIG. 2, the liquid crystal display device 10 includes a TFT substrate 20, which is an active matrix substrate, a counter substrate 40, which is a color filter substrate, and a liquid crystal layer 50 provided between these substrates. The liquid crystal layer 50 contains a nematic liquid crystal material having a negative dielectric anisotropy (Δ∈<0).

A polarizing plate 60a is provided outer to the TFT substrate 20 (a surface of the TFT substrate 20 on the side opposite to the liquid crystal layer 50), and a polarizing plate 60b is provided outer to the counter substrate 40. The polarizing plats 60a and 60b are placed in crossed Nicols. As shown in FIG. 1, a transmission axis 14a of one of the polarizing plate extends in the X direction, and a transmission axis 14b of the other polarizing plate extends in the Y direction. In the following description, the azimuth directed from left to right in FIG. 1 is referred to as the “0° azimuth”, and azimuthal angles are defined counterclockwise in a substrate plane based on the 0° azimuth.

As shown in FIG. 1 and FIG. 2, the TFT substrate 20 includes a glass plate (transparent plate) 21, and an insulating layer 25 formed of a plurality of layers formed on the glass plate 21. Between the glass plate 21 and the insulating layer 25, scanning lines (gate bus lines) 22 and storage capacitance lines (Cs lines) 24 are formed. In the insulating layer 25, TFTs 35 and signal lines (source bus lines) 23 are formed. On the insulating layer 25, pixel electrodes 30 are formed, and an alignment film (vertical alignment film) 32 is formed on the insulating layer 25 so as to cover the pixel electrodes 30.

Each pixel 15 includes a pixel electrode 30 of a fishbone type. A source electrode of the TFT 35 formed in correspondence with the pixel 15 is connected to a corresponding signal line 23 extending in the Y direction, and a drain electrode of the TFT 35 is connected to the pixel electrode 30 via a contact hole. A gate electrode of the TFT 35 is connected to a corresponding scanning line 22 extending in the X direction between two adjacent pixels 15. Between the pixel electrode 30 and a corresponding storage capacitance line 24, a storage capacitance electrode 36 is formed. The storage capacitance electrode 36 is electrically connected to the pixel electrode 30 via a contact hole. The storage capacitance electrode 36 and a part of the storage capacitance line 24 form a storage capacitance.

As shown in FIG. 2, the counter substrate 40 includes a transparent plate 41, a color filter (CF layer) 42 provided on the transparent plate 41 (on a surface of the transparent plate 41 on the liquid crystal layer side), a counter electrode (common electrode) 45 formed on the color filter 42, and an alignment film (vertical alignment film) 44 formed on the counter electrode 45.

Neither on the alignment film 32 on the TFT substrate 20 nor on the alignment film 44 on the counter substrate 40, alignment sustaining layers for pretilting liquid crystal molecules are formed. Therefore, in the absence of a voltage, the liquid crystal molecules in the liquid crystal layer 50 are aligned vertically to the substrate surface.

Now, the shapes of the pixel electrode 30 and the counter electrode 45 will be described.

As shown in FIGS. 1 and 3(a), the pixel electrode 30 includes a plurality of branch portions (first branch portions) 30a extending in an azimuthal angle direction of 0° (e.g., first direction), a plurality of branch portions (second branch portions) 30b extending in an azimuthal angle direction of 180° (opposite to the first direction), and a trunk portion (first trunk portion) 30c extending in the Y direction (azimuthal angle direction of)90°-270°. The plurality of branch portions 30a and 30b both continuously extend from the trunk portion 30c. For easier explanation, FIGS. 1 and 3(a) show the branch portions 30a and 30b as being provided by a number different from the actual number thereof. The number and size of the branch portions 30a and 30b according to the present invention are not limited to those in this embodiment.

The pixel electrode 30 has such a shape. Therefore, between two adjacent branch portions 30a, a plurality of slits (gaps in which no electrode material is present) 31a extending in the same direction as the branch portions 30a are formed. Between two adjacent branch portions 30b, a plurality of slits 31b extending in the same direction as the branch portions 30b are formed.

The branch portions 30a and 30b each have a width a (width in the direction perpendicular to the direction in which the branch portions extend) of 2.5 μm. In order to provide an effect by the present invention described later, it is preferable that the width a is 1.5 μm or greater and 8.0 μm or less. The slits 31a and 31b each have a width b (width in the direction perpendicular to the direction in which the slits extend) of 2.5 μm. In order to provide the effect by the present invention described later, it is preferable that the width b is 1.5 μm or greater and 5.0 μm or less. The trunk portion 30c has a width c (width in the direction perpendicular to the direction in which the trunk portion extends) of 2.5 μm. It is preferable that the width c is 1.5 μm or greater and 5.0 μm or less. The pixel electrode 30 has a width A of 50 μm in the X direction and has a width B of 100 μm in the Y direction. It is preferable that the width A is 25 μm or greater and 100 μm or less and that the width B is 75 μm or greater and 300 μm or less.

Now, the shape of the counter electrode 45 corresponding to one pixel 15 will be described.

FIG. 3(b) shows the shape of a part of the counter electrode 45, the part facing the pixel electrode 30. As shown in FIG. 3(b), the counter electrode 45 includes a plurality of branch portions (third branch portions) 45a extending in an azimuthal angle direction of 90° (e.g., second direction), a plurality of branch portions (fourth branch portions) 45b extending in an azimuthal angle direction of 270° (opposite to the second direction), and a trunk portion (second trunk portion) 45c extending in the X direction. The plurality of branch portions 45a and 45b both continuously extend from the trunk portion 45c. For easier explanation, FIG. 3(b) shows the branch portions 45a and 45b as being provided by a number different from the actual number thereof. The number and size of the branch portions 45a and 45b according to the present invention are not limited to those in this embodiment.

The counter electrode 45 has such a shape. Therefore, between two adjacent branch portions 45a, a plurality of slits 46a extending in the same direction as the branch portions 45a are formed. Between two adjacent branch portions 45b, a plurality of slits 46b extending in the same direction as the branch portions 45b are formed.

The branch portions 45a and 45b each have a width of 2.5 μm. In order to provide the effect by the present invention described later, it is preferable that the width is 1.5 μm or greater and 8.0 μm or less. The slits 46a and 46b each have a width of 2.5 μm. In order to provide the effect the present invention described later, it is preferable that the width is 1.5 μm or greater and 5.0 μm or less. The trunk portion 45c has a width of 2.5 μm. It is preferable that the width c is 1.5 μm or greater and 5.0 μm or less.

FIG. 3(b) shows a part of the counter electrode 45, the part facing the pixel electrode 30. Electrode portions of the counter electrode 45 are also formed in other areas of one pixel. Therefore, ends of the branch portions 45a and 45b are each electrically connected to a part of the counter electrode 45 corresponding to an adjacent pixel 15 by such an electrode portion not shown. The counter electrode 45 may be structured such that the plurality of slits 46a are communicated to slits 46b facing the slits 46a with no trunk portion 45c being formed.

Now, the alignment of the liquid crystal molecules in the liquid crystal display device 10 will be described.

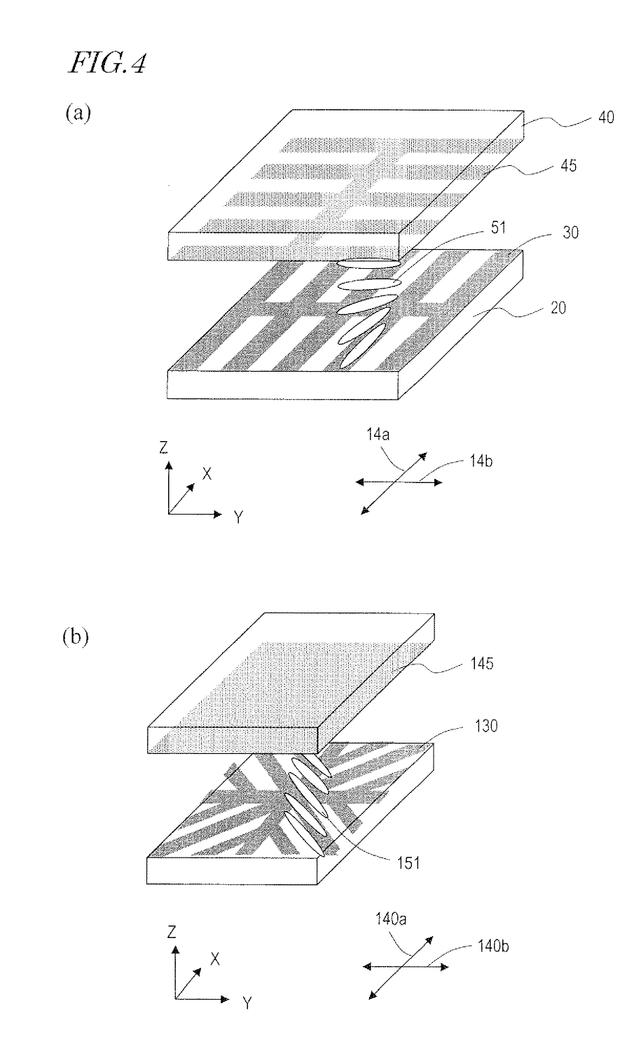

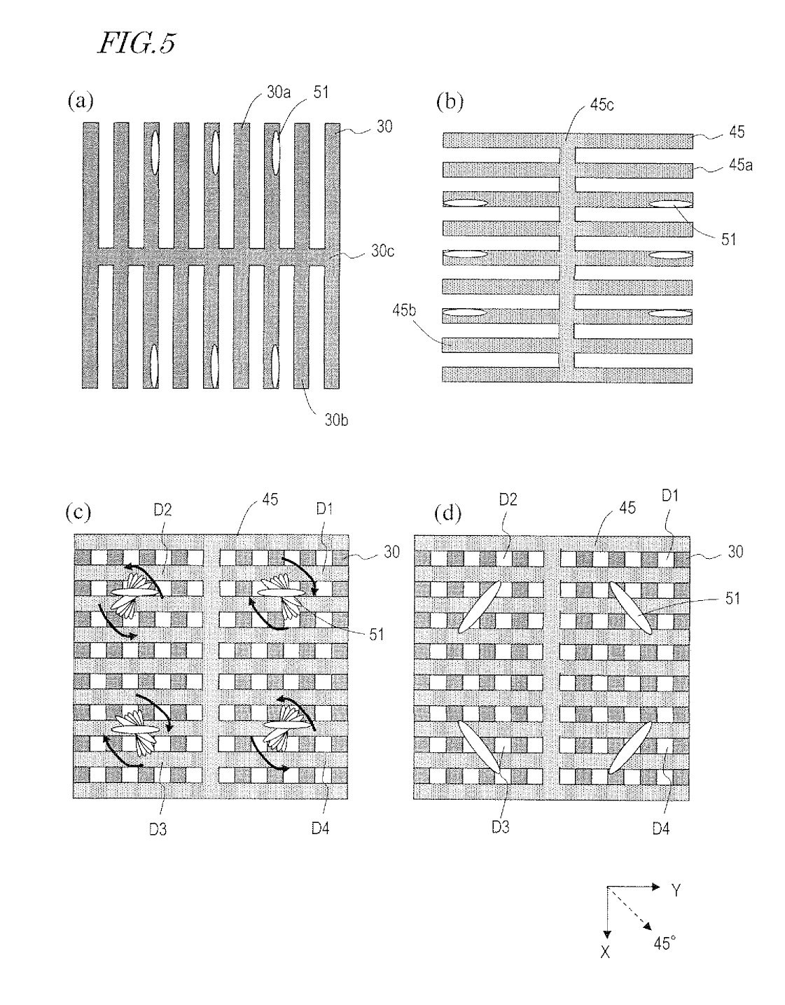

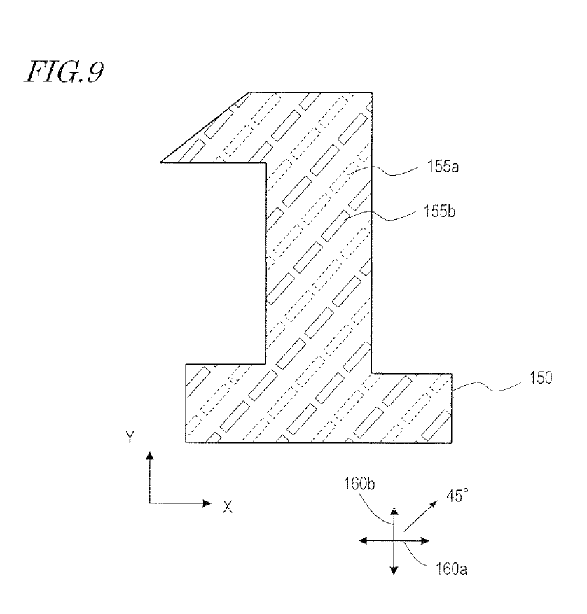

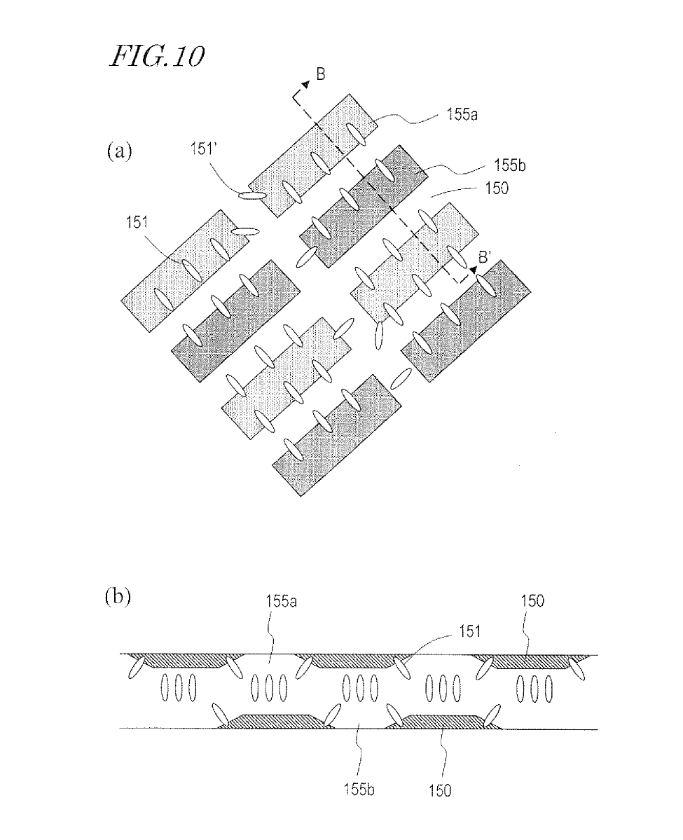

FIG. 4(a) shows the alignment of liquid crystal molecules 51 in the liquid crystal display device 10, and FIG. 4(b) shows the alignment of the liquid crystal molecules 151 in a conventional liquid crystal display device including the pixel electrode 130 of the fishbone type as shown in FIG. 8. FIGS. 5(a) and 5(b) respectively show a state of the liquid crystal molecules 51 in the vicinity of the pixel electrode 30 and a state of the liquid crystal molecules 51 in the vicinity of the counter electrode 45, in the presence of a voltage. FIG. 5(c) shows an alignment state (twisted state) of the liquid crystal molecules 51 in four domains D1 through D4 formed when a voltage is applied, the alignment state being seen from the counter substrate 40 side. FIG. 5(d) shows average alignment directions of the liquid crystal molecules 51 in the four domains D1 through D4. FIG. 5(d) shows the alignment directions of the liquid crystal molecules 51 in a middle portion of the liquid crystal layer 50 in the thickness direction.

In the liquid crystal display device 10, when no voltage is applied between the pixel electrode 30 and the counter electrode 45, the liquid crystal molecules 51 are aligned vertically to the substrate surface by the action of the alignment films 32 and 44. Since no alignment sustaining layers is formed on the alignment film 32 or 44, the liquid crystal molecules 51 are not pretilted. Therefore, high contrast display can be provided with light leaks being suppressed in black display.

When a voltage is applied to the liquid crystal layer 50, as shown in FIG. 4(a), the liquid crystal molecules 51 start to be aligned in a direction closer to the direction parallel to the substrate surface (surface of the TFT substrate 50 or the counter substrate 40, or the X-Y plane); and when the maximum luminance voltage is given, the liquid crystal molecules 51 are aligned to be parallel to the substrate surface.

In the presence of a voltage, as shown in FIG. 5(a), the alignment direction (azimuthal angle) in the substrate plane (in the X-Y plane) of the liquid crystal molecules 51 located in the vicinity of the TFT substrate 20 is parallel to the branch portions 30a and 30b. Namely, the liquid crystal molecules 51 in the vicinity of the branch portions 30a and the slits 31a are aligned along the X direction nearly uniformly by the branch portions 30a and the slits 31a. The liquid crystal molecules 51 in the vicinity of the branch portions 30b and the slits 31b are aligned along the X direction nearly uniformly by the branch portions 30b and the slits 31b. In the case where the liquid crystal molecules 51 are not completely parallel to the substrate surface (when the maximum luminance voltage is not given), the liquid crystal molecules 51 are aligned such that an end thereof on the trunk portion 30c side is directed upward.

In the presence of a voltage, as shown in FIG. 5(b), the alignment direction in the substrate plane of the liquid crystal molecules 51 located in the vicinity of the counter substrate 40 is parallel to the branch portions 45a and 45b. Namely, the liquid crystal molecules 51 in the vicinity of the branch portions 45a and the slits 46a are aligned along the Y direction nearly uniformly by the branch portions 45a and the slits 46a. The liquid crystal molecules 51 in the vicinity of the branch portions 45b and the slits 46b are aligned along the Y direction nearly uniformly by the branch portions 45b and the slits 46b. In the case where the liquid crystal molecules 51 are not completely parallel to the substrate surface, the liquid crystal molecules 51 are aligned such that an end thereof on the trunk portion 45c side is directed upward.

In accordance with the above-described alignment of the liquid crystal molecules 51 in the vicinity of each of the substrates, as shown in FIG. 5(c), the liquid crystal molecules 51 in the inner portion of the liquid crystal layer 50 change the alignment direction thereof continuously so as to be twisted at 90° between the counter substrate 40 side and the TFT substrate 20 side. Owing to this, four liquid crystal domains D1 through D4 having different twisting directions of the liquid crystal molecules 51 are formed in the liquid crystal layer 50. In the presence of a voltage, the liquid crystal molecules 51 in a middle portion of the liquid crystal layer 50 (central portion when seen in the direction vertical to the substrate surface) are all aligned parallel to the substrate surface. The azimuthal angle thereof is, as shown in FIG. 5(d), 45° in the domain D1, 315° in the domain D2, 225° in the domain D3, and 135° in the domain D4.

In this manner, the four-domain alignment structure is realized in the liquid crystal layer 50. In the presence of a voltage, the polarization plane of the incident light which has been transmitted through the polarizing plate 60a is rotated along the twist of the liquid crystal molecules 51 and thus can be transmitted through the polarizing plate 60b. Therefore, bright display is provided. Since the twisting directions of the liquid crystal molecules 51 are different among the domains, the provided display has good viewing angle characteristics with less variance in the viewing angle in accordance with the azimuthal angle.

In a conventional liquid crystal display device using the pixel electrode 130 of the fishbone type as shown in FIG. 4(b), in the absence of a voltage, the liquid crystal molecules 151 are pretilted by the alignment sustaining layers formed by the PSA technology. Therefore, light leaks in black display. In addition, the production of such a liquid crystal display device requires a step of forming the alignment sustaining layers, which lowers the production efficiency and raises the cost. There is another problem that the counter electrode 145 has no branch portion and so the alignment of the liquid crystal molecules 151 is unstable and a desired contrast is not provided.

Now, an effect provided by the liquid crystal display device 10 will be described.

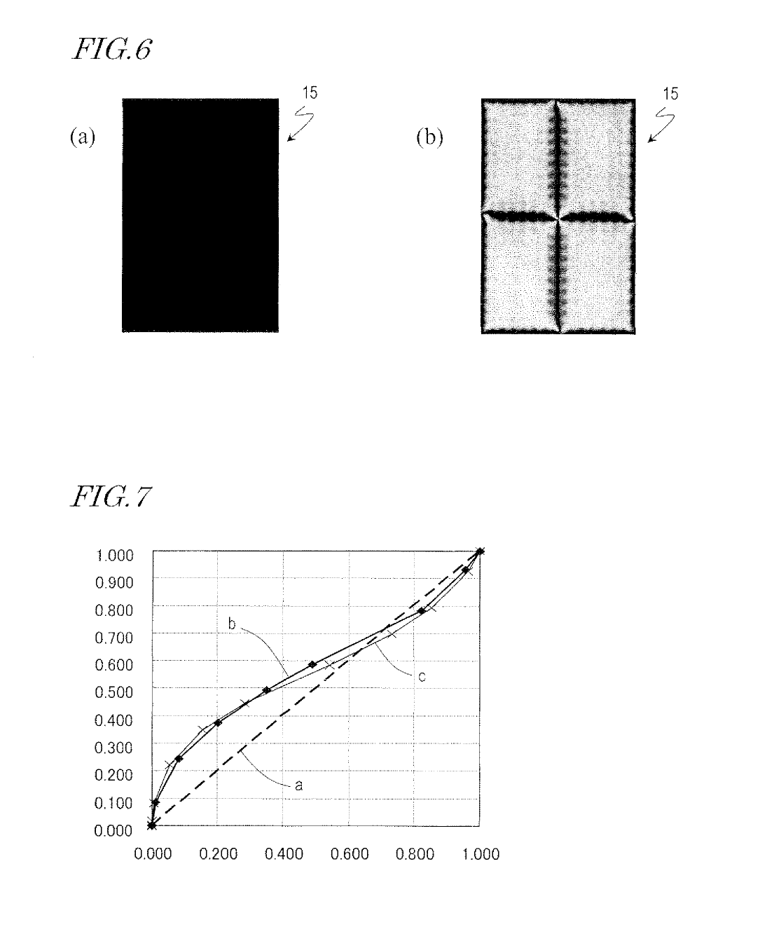

FIG. 6(a) shows the luminance of the pixel 15 in the absence of a voltage (black display state), and FIG. 6(b) shows the luminance of the pixel 15 when a maximum display voltage is applied (brightest state). In the liquid crystal display device 10, the liquid crystal molecules 51 are aligned in a direction closer to the direction vertical to the substrate surface in the absence of a voltage. Therefore, as shown in FIG. 6(a), nearly completely black display is obtained. In the presence of a voltage, the liquid crystal molecules 51 are stably aligned in each of the domains D1 through D4. Therefore, as shown in FIG. 6(b), nearly uniformly bright display is obtained except for the borders between the liquid crystal domains corresponding to the trunk portions 30c and 45c. Accordingly, the liquid crystal display device 10 provides display of a very high contrast.

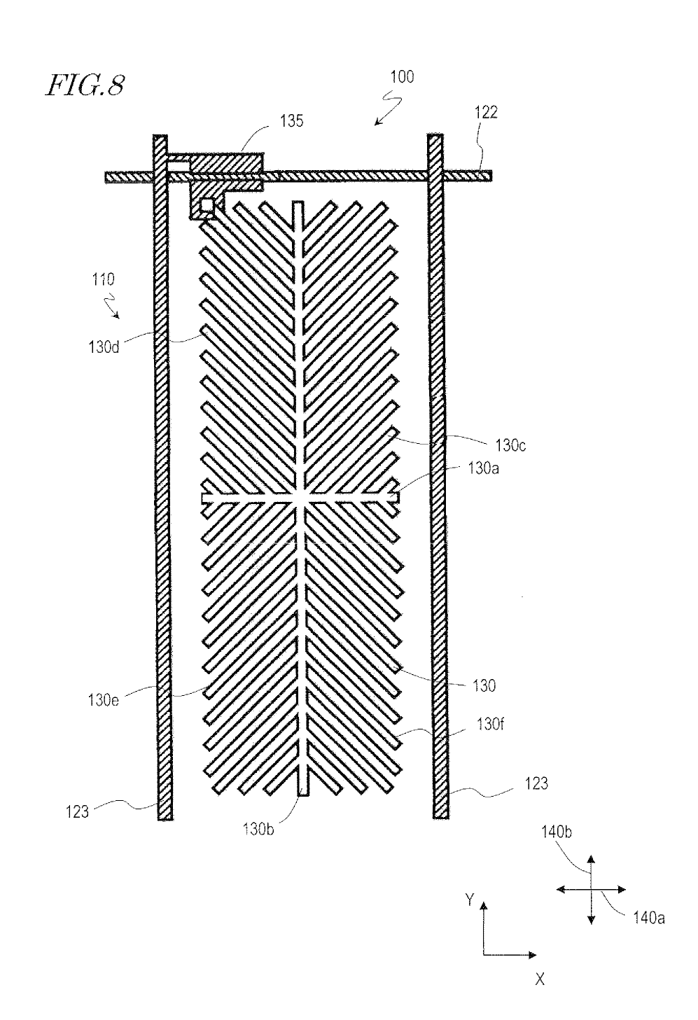

FIG. 7 is a graph comparing the viewing angle characteristics of the liquid crystal display device 10 with those of the conventional liquid crystal display device 100. The horizontal axis of the graph represents the transmittance (where the maximum transmittance is 1.0) when the liquid crystal display device is seen from the front surface (in the direction vertical to the substrate surface or the direction of a polar angle of 90°). The vertical axis of the graph represents the transmittance (where the maximum transmittance is 1.0) when the liquid crystal display device is seen in the direction of a polar angle of 45° and an azimuthal angle of 0° (or 180°).

In FIG. 7, “a” (dashed line) represents the ideal viewing angle characteristics in which the luminance in the front direction is equal to the luminance at a polar angle of 45° (relationship between the transmittance on the front surface and the transmittance in the direction of a polar angle of 45°). “b” (line connecting black diamonds) and “c” (line connecting X”) represent the viewing angle characteristics of the liquid crystal display device 10 and the liquid crystal display device 100, respectively. The width of each of the branch portions and the slits of the pixel electrode 130 in the liquid crystal display device 100 is 3.5 μm. It is under stood from FIG. 7 that the liquid crystal display device 10 provides good viewing characteristics of approximately the same level as that of the liquid crystal display device 100.

Therefore, the present invention provides a liquid crystal display device which can provide display having a very high contrast and good viewing characteristics of the same level as that of a conventional liquid crystal display device and can be produced with a smaller number of steps with a high efficiency.

### INDUSTRIAL APPLICABILITY

The present invention is usable to improve the display characteristics of various types of liquid crystal display devices, and is especially preferably usable for a liquid crystal display device having relatively small pixels.

### REFERENCE SIGNS LIST

10, 100 Liquid crystal display device
14a, 14b Transmission axis
15, 110 Pixel
20 TFT substrate
21, 41 Transparent plate
22, 122 Scanning line
23, 123 Signal line
24 Storage capacitance line
25 Insulating layer
30, 130 Pixel electrode
30a, 30b, 45a, 45b Branch portion
30c, 45c Trunk portion
31a, 31b, 46a, 46b Slit
32, 44 Alignment film
35, 135 TFT
36 Storage capacitance electrode
40 Counter substrate
42 Color filter
45, 145 Counter electrode
50 Liquid crystal layer
51, 151 Liquid crystal molecules
60a, 60b Polarizing plate
150 Pair of electrodes
155a, 155b Slit
140a, 140b, 160a, 160b Transmission axis

1. A liquid crystal display device of a vertical alignment type including a plurality of pixels, the liquid crystal display device comprising:
a TFT substrate including a plurality of pixel electrodes and a plurality of TFTs both in correspondence with the plurality of pixels, respectively;
a counter substrate including a counter electrode facing the plurality of pixel electrodes; and
a liquid crystal layer located between the TFT substrate and the counter substrate;
wherein:
the plurality of pixel electrodes each include a first trunk portion, a plurality of first branch portions extending from the first trunk portion in a first direction, and a plurality of second branch portions extending from the first trunk portion in a direction opposite to the first direction; and
the counter electrode includes, in each of the plurality of pixels, a plurality of branch portions extending in a second direction, which is perpendicular to the first direction in a substrate plane.

2. The liquid crystal display device of claim 1, wherein:
the counter electrode includes, in each of the plurality of pixels, a second trunk portion extending in a direction different from the second direction; and
the branch portions of the counter electrode include a plurality of third branch portions extending from the second trunk portion in the second direction and a plurality of fourth branch portions extending in a direction opposite to the second direction.

3. The liquid crystal display device of claim 1, wherein the second trunk portion extends in a direction perpendicular to the second direction in the substrate plane.

4. The liquid crystal display device of claim 1, wherein the first trunk portion extends in a direction perpendicular to the first direction in the substrate plane.

5. The liquid crystal display device of claim 1, wherein the plurality of first branch portions and the plurality of second branch portions each have a width of 1.5 μm or greater and 8.0 μm or less.

6. The liquid crystal display device of claim 1, wherein the plurality of branch portions of the counter electrode each have a width of 1.5 μm or greater and 8.0 μm or less.

7. The liquid crystal display device of claim 1, wherein slits interposed between two adjacent first branch portions, among the plurality of first branch portions, and slits interposed between two adjacent second branch portions, among the plurality of second branch portions, each have a width of 1.5 μm or greater and 5.0 μm or less.

8. The liquid crystal display device of claim 1, wherein slits interposed between two adjacent branch portions, among the plurality of branch portions of the counter electrode, each have a width of 1.5 μm or greater and 5.0 μm or less.

9. The liquid crystal display device of claim 1, further comprising:
a first polarizing plate attached to the TFT substrate and having a transmission axis extending parallel or perpendicular to the first direction; and
a second polarizing plate attached to the counter substrate and having a transmission axis perpendicular to the transmission axis of the first polarizing plate.

10. The liquid crystal display device of claim 1, wherein an alignment film is provided, on a surface of at least one of the TFT substrate and the counter substrate on the liquid crystal layer side, so as to be in contact with the liquid crystal layer, the alignment film being for aligning liquid crystal molecules vertically to the surfaces of the substrates in the absence of a voltage.

11. The liquid crystal display device of claim 1, wherein the liquid crystal molecules located in a middle portion of the liquid crystal layer in a direction vertical to the surfaces of the substrates are aligned in a direction of 45° with respect to the first direction in the substrate plane when a voltage is applied.

12. The liquid crystal display device of claim 1, wherein the liquid crystal molecules located in the vicinity of the TFT substrate are aligned parallel to the first branch portions or the second branch portions in the substrate plane when a voltage is applied.

13. The liquid crystal display device of claim 1, wherein the liquid crystal molecules located in the vicinity of the counter substrate are aligned parallel to the branch portions of the counter electrode in the substrate plane when a voltage is applied.
